(19) United States
(12) Patent Application Publication
(10) Pub. No.: US 2016/0350297 A1
(43) Pub. Date: Dec. 1, 2016

(54) Location Based Social Media System

(71) Applicant: Aslan Leo Riza, Sarasota, FL (US)

(72) Inventor: Aslan Leo Riza, Sarasota, FL (US)

(21) Appl. No.: 15/083,255

(22) Filed: Mar. 28, 2016

Related U.S. Application Data
(60) Provisional application No. 62/138,956, filed on Mar. 26, 2015.

(51) Int. Cl. G06F 17/30

(52) U.S. Cl. CPC G06F 17/30017; G06F 17/30289; G06F 3/0481

(57) ABSTRACT

The present invention is directed to recording and providing media files based on a location. Such systems and methods maybe transacted by a client application or a processor in communication with one or more electronic devices. The system can be accessed through a website or through mobile platform applications. Certain content can only be added through a mobile device in which GPS data and photo time stamping will be accessed. Content will be viewable by users in the form of a stack of media files (e.g. photos) with related comments in which this content is prioritized by time and algorithmic methods. Users will have the ability to communicate with other users through the system while advertising can be set up in the mobile application with payment occurring through in-app purchasing mechanism.

### FIELD OF INVENTION

This invention relates to the field of computer-implemented methods for capturing digital media providing same within a social media environment.

### SUMMARY OF INVENTION

The present invention is generally directed to media and location based social networking. More specifically, the present invention is directed to methods and systems for capturing digital media (e.g. images, video or other media files) associated with a location, and providing the media files associated with a location to one or more users.

There are numerous applications, software, and devices that enable users to share, often times via social media, certain thoughts, or pictures. Such thoughts or pictures may be tagged by subject matter, user, etc. for information purposes. However, it is desirable to have a method that combines geo-location and user-submitted media to drive how information is distributed.

For the purposes of summarizing this invention, the invention comprises a multi-platform mobile application and website acting as a vehicle for the exchange of location relevant information. Users of the application can post content which includes a photo and a related comment. This content is then viewable by other users in the form of a stack of the photos with related comments. Users can sort through the stacks, which will display photos related to different locations. When a geographic location of interest is found, users can view all images and posts related to the location. Other display mechanisms may also be utilized.

The system may also be used with other types of sites, such as traditional news sites, which may provide content that is associated with particular geographic locations (e.g., geotagged, etc.). In one embodiment, the system may provide relevant (e.g., by location, subject-matter, based on profile, etc.) advertisements to the user. It is to be appreciated that advertising could be sold based on any number of demographics and added to the content “feed” with other content.

In order to exchange data with providers, the system may utilize a provider's application programming interface (API), although not limited thereto. The system according to the present teachings may store the interface requirements for any number of different providers so that content can be formatted appropriately and sent to a provider Similarly, the system may retrieve relevant content from the provider and format it to display to users of the system. One skilled in the art would appreciate that there are many ways to interface with providers in order to exchange data and the present teaching are not limited to any particular embodiment disclosed herein.

### BRIEF DESCRIPTION OF THE DRAWINGS

For a fuller understanding of the invention, reference should be made to the following detailed description, taken in connection with the accompanying drawings, in which:

FIG. 1 is a schematic diagram of one embodiment of the system according to the present teachings;

FIG. 2 is a block diagram that shows the way the image is uploaded to the cloud;

FIG. 3 is a diagram that illustrates the type of data transferred with the media/file;

FIG. 4 is a block diagram that shows the way the images are stacked;

FIG. 5 is a block diagram that shows the way the images are credited;

FIG. 6 is a block diagram that shows the way the images are clustered;

FIG. 7 is a block diagram that shows the way a user inputs properties for image;

FIG. 8 is a diagram that shows the way the images are clustered;

FIG. 9 is flow chart demonstrating overall flow chart of the general process of the inventive system; and

FIG. 10 is a detailed flow chart of the one embodiment of the inventive system.

FIGS. 11A-11C are tables showing two input variables that the system will look into that will be determined by the active area, these parameters are minimum image count and Minimum amount in neighboring squares.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention

The system, in a general embodiment, allows users to upload photos at a particular time and place. Additionally, the system allows the user to see what has taken place in the past at the same location. The system according to the present teachings allows users to create, post and retrieve content such as comments/pictures/videos/etc. (e.g., social media content, generically referred to as “content”) that is associated with a geographic location. In a preferred embodiment the system restricts a user from uploading (e.g., posting, sharing, etc.) content associated with a particular geographic location unless the user is at that location or the content includes metadata that matches the geographic location (e.g. gps data embedded in the content). For example, a user may provide a review of a local establishment by uploading an image and commenting on an experience. However, it would be helpful to other users if they had some confidence that the review was created by someone who was actually at the restaurant and not simply an artificial review. The system according to the present teachings can help accomplish this and other objectives.

In order to accomplish one or more of the objectives of the present teachings, social media content may be associated with a geographic location. This may be performed automatically based on the geographic location of where the content is created and/or uploaded, although not limited thereto. In another embodiment, a user may select the location with certain parameters, such as zip code, place name, etc. and manually assign a geographic location to social media content. The system may provide an indicator (e.g., location information, a confirmation flag, or some other indicator) that the content is relevant to a particular location. A “location” can be an event (e.g., a parade), an establishment (e.g., a restaurant), or some other identifier of a geographic location, although not limited thereto.

In one embodiment, a user has to be within a predetermined range of the geographic location (e.g., 500 ft, 1 mile, 5 miles) to view and/or create associated social media content. In an alternative embodiment, a user may select the location with certain parameters, such as zip code, place name, etc. in order to view social media content associated with a particular geographic location. In addition, even though a user may be able to view content from anywhere, users may only create content if they are actually at or within a certain radius of the location, although not limited thereto.

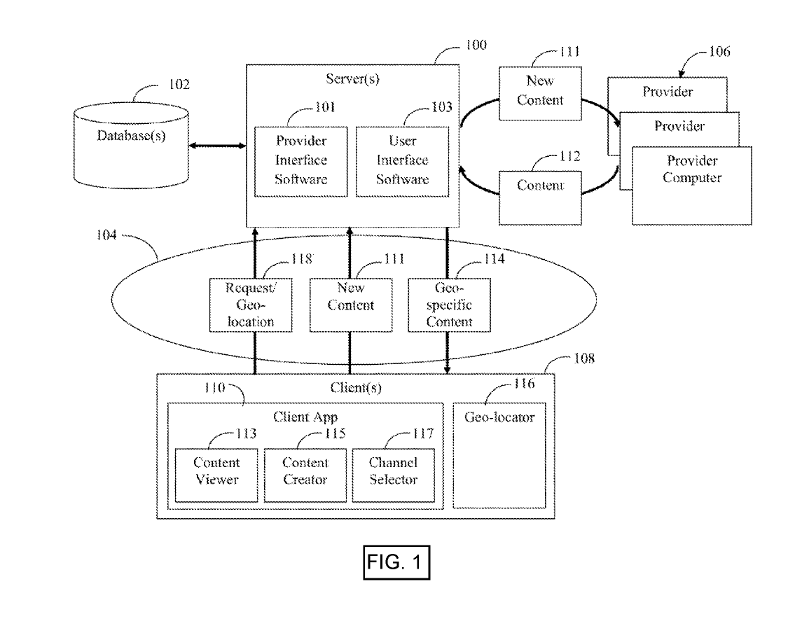

Referring now to FIG. 1, shown is one embodiment of the system according to the present teachings. The system may comprise a server or servers 100 having software that manages the receipt and distribution of content. It is to be appreciated that the functionality described herein may be provided in hardware, software, or any combination thereof. However, software executing on computer readable media may be preferred.

Optionally, the server 100 may integrate with one or more providers 106 (e.g., social networking systems like Facebook, Twitter, etc.) in order to exchange social content. For example, the social content may be stored in a provider's database(s) and/or the system's database(s) 102, although not limited thereto. This may be performed by provider interface 101 software.

In one embodiment, the provider interface 101 software may request content 112 from providers 106, which it can store in its database 102 and distribute to users of the system as geo specific content 114. It is to be appreciated that content received from providers 106 may have location information (e.g., be geo-tagged) in order to associate it with a geographic location, or subject-matter information (e.g., comments, picture title, etc.) to associate it with a channel, although not limited thereto. Provider interface 101 software may also send new content 111 (e.g., created by users of the system) to the provider 106. This way, the new content 111 can be shared on other social networking systems, although not limited thereto.

Using a client device 108, users may access the system in order to upload and view content. Access may be over a network 104 such as the Internet. A client device may be any configured computer, including a desktop PC, laptop, tablet, smart phone, iPhone, iPad, Blackberry, Android phone, etc. Content may be created by accessing user interface 103 software provided by the server 100, such as a website, API or some other interface. In another embodiment, a user may utilize a mobile device such as a smart phone (or tablet, laptop, etc.) and download a client app 110. The client app 110 may provide functionality for the user to upload social media content to the system and retrieve content from the system, discussed further below.

Preferably the client device 108 includes a geolocator 116 that may tag new content with a geographic location. A geolocator 116 may be a GPS, or some other technology for determining the location of the client device 108.

The client device 108 may have software running on it to perform various functions, discussed further below in reference to various exemplary user interfaces. For example, a content viewer 113 may provide a user interface for showing the geo-specific content 114 to a user. A content creator 115 may provide a user interface for creating new content 111. A channel selector 117 may provide a user interface for selecting subject-matter channels of content. In operation, a user of the client device 108 may send a request 118 (e.g., select a channel, provide filter criteria, identify geographic boundaries, etc.) for content and the server 100 will return relevant geo-specific content 114 to the user. In one embodiment, the request 118 may only include the location of the client device 108 as provided by the geolocator 166, although not limited thereto.

In one embodiment, users of the system may register with the system. In this way, they may create a profile and social networks of linked users, although not limited thereto. Users may also be pre-approved in order to provide social media content. For example, a user may be granted permission to upload content relating to a particular geographic location by the location's owner. In this way, the system may be a private social network and the system may provide groups of users associated with geographic locations, although not limited thereto. In some embodiments, the user may post to or share the content with a particular social networking application or predetermined recipients. Permissions may also be granted for users to comment or supplement social media content uploaded by others. For example, a user may only be able to comment on social media content uploaded by a linked user. In another embodiment, the user may only comment on social media content if that user is also at the associated geographic location. It is to be appreciated that there are a variety of ways of controlling access to edit and view social media content according to the present teachings, as would be appreciated by one skilled in the art, and the present teachings are not limited to any particular embodiment disclosed herein.

In another embodiment, the system may categorize the social media content, which may be performed in any number of different ways. For example, the system may have area-specific “channels” targeting particular geographic locations or venues. These may be completely open, have posts monitored and approved before being posted, and/or allow only approved users to submit posts, although not limited thereto. Such a system may allow users to tune into a particular channel and view relevant social content as it is being created and uploaded. Channels may also be created for particular user characteristics (e.g., demographics, etc.), subjects, etc., although not limited thereto.

The user interface may provide a list of all content that is associated with a geographic location in proximity to the user. The user may optionally select to view only content posted within a predetermined distance from the user at any given time (e.g., 500 ft, 1 mile, 5 miles). This way, a user may more easily view geo-relevant content. Using “channels,” a user may also search for content associated with a particular subject-matter. For example, the user may want to see all content within 1 mile relating to restaurants, music, or shopping, although not limited thereto. This may allow a user to identify positive reviews for a restaurant or be alerted to shopping sales, although not limited thereto. A user may select the content or select the associated geographic location for more detail, although not limited thereto. As a user travels the system may track the user's location. This may be performed by the user's mobile device, which may have a geolocator such as a GPS or similar technology, although not limited thereto. A map may allow the user to view the map.

When a user travels in proximity to a geographic location for which there is associated content, the system may provide an indicator. The system may automatically show associated social media content when the user gets within a predetermined proximity to the geographic location, although not limited thereto. In another embodiment, a user may select the indicator (e.g., tap on screen, etc.) in order to view the associated social media content.

A user may select the social media content in order to view more detailed information. For example, a detail screen may provide information on when/where the content was created, by whom, and any associated media content (e.g., likes, comments, category, etc.), although not limited thereto.

The system according to the present teachings allows content creators to post and retrieve content such as comments/pictures/videos/etc. (e.g., social media content, generically referred to as “content”) that is associated with a geographic location. Optionally, the system may restrict a user from uploading (e.g., posting, sharing, etc.) social media content associated with a particular geographic location unless the user is at that location. For example, a user may provide a review of a local restaurant by uploading an image and commenting on a meal. However,

As noted above, the present invention is generally directed to the recordation and replay of various media files, based at least in part on a geographic location. Media files may include audio, video, images, animation, and/or any other sort of media capable of transmitting information to a user. Note further that while “audio” is discussed herein, such files may be stored, recalled, played, and used in any number of formats, including but not limited to: 3pg, act, AIFF, aac, ALAC, ALS, ASF, Au, AVI, dct, dvf, flac, gsm, m4a, m4p, mp3, mpc, mpeg, msv, ogg, Opus, ra, rm, TTA, vox, way, wma, or xmf. Moreover, audio files may be saved in formats not typically utilized for audio only recordings, based upon device capabilities, storage parameters, data requirements, etc.

In order to accomplish one or more of the objectives of the present teachings, social media content may be associated with a geographic location. This may be performed automatically based on the geographic location of where the content is created and/or uploaded, although not limited thereto. In another embodiment, a user may select the location with certain parameters, such as zip code, place name, etc. and manually assign a geographic location to social media content. The system may provide an indicator (e.g., location information, a confirmation flag, or some other indicator) that the content is relevant to a particular location. A “location” can be an event (e.g., a parade), an establishment (e.g., a restaurant), or some other identifier of a geographic location, although not limited thereto.

As used herein, a “location” may refer to a specific unique location (for example, an exact longitude and latitude of 24.5553° N, 81.7828° W), or may refer to a general area, town, city, etc. Moreover, “location” may be associated with several geographic locations that have a unifying feature. For example, a location may be defined as “Carnegie Mellon University,” but geographically may include both a Carnegie Mellon campus in Pittsburgh, Pa., but also include a Carnegie Mellon campus in Moffett Field, Calif. Similarly, media files associated with a chain retail outlet or restaurant may be associated with multiple geographic locations of such chain retail outlet or restaurant.

Note that while the invention generally discusses recording media while the contributor is at a geographic location that is associated with the media, it is also contemplated that a user may record and associate media with a geographic location when the contributor is not at the geographic location. For example, a contributor may record a reminder to be presented when a recipient is at a specific location. Another example may be where a contributor records a media file after visiting a geographic location and associates the media with the geographic location at a subsequent time. Another example may be where a contributor records or associates a media unrelated with geographic areas, with certain geographic areas—for example, thereby creating a geographically driven playlist for road-trips, long-distance runs, scavenger hunts, etc.

The system may comprise a server or servers having software that manages the receipt and distribution of content. It is to be appreciated that the functionality described herein may be provided in hardware, software, or any combination thereof. However, software executing on computer readable media may be preferred.

As the discussion below explains, a recipient may be empowered to select options or preferences as to content, geographic range, submitter of the media, provision rules, etc. More specifically, with regard to content a recipient may select to receive media files associated or tagged with a certain location, topic or topics.

With regard to submitter of the media, a recipient may create groupings of submitters, or may use pre-existing groupings. Social media has caused numerous categorizations of people. For example, FaceBook has “friends” and inner circles and groupings within such “friends.” The professional networking site LinkedIn provides not only groups that users may belong to, but lists the degrees of connectedness a user may have to another user in the system. Even products such as mobile telephones running Windows Phone operating systems enables users to break down contacts into groups. Accordingly, some embodiments of the present invention may enable a recipient or contributor to establish their own groups from whom they want to receive and contribute media to, respectively. Alternatively, it is contemplated that in accordance with some embodiments of the present invention a recipient or contributor may use preexisting or pre-established groups in various social networking sites or contacts lists to sort from whom they want to receive or contribute media.

With respect to provision rules, a recipient may elect options as to how the recipient would like the media provided to the recipient. Such rules may set the device to which the media is provided (for example, a mobile telephone, tablet computer, e-reader, laptop, navigation system, etc.), as well as how often to provide the information. For example, in accordance with some embodiments of the present invention, a recipient may be presented with a list or graphical display of media files, or stack, associated with the recipient's location (or within a range of the location). The recipient may then select which, if any, of the media files the recipient would like to receive.

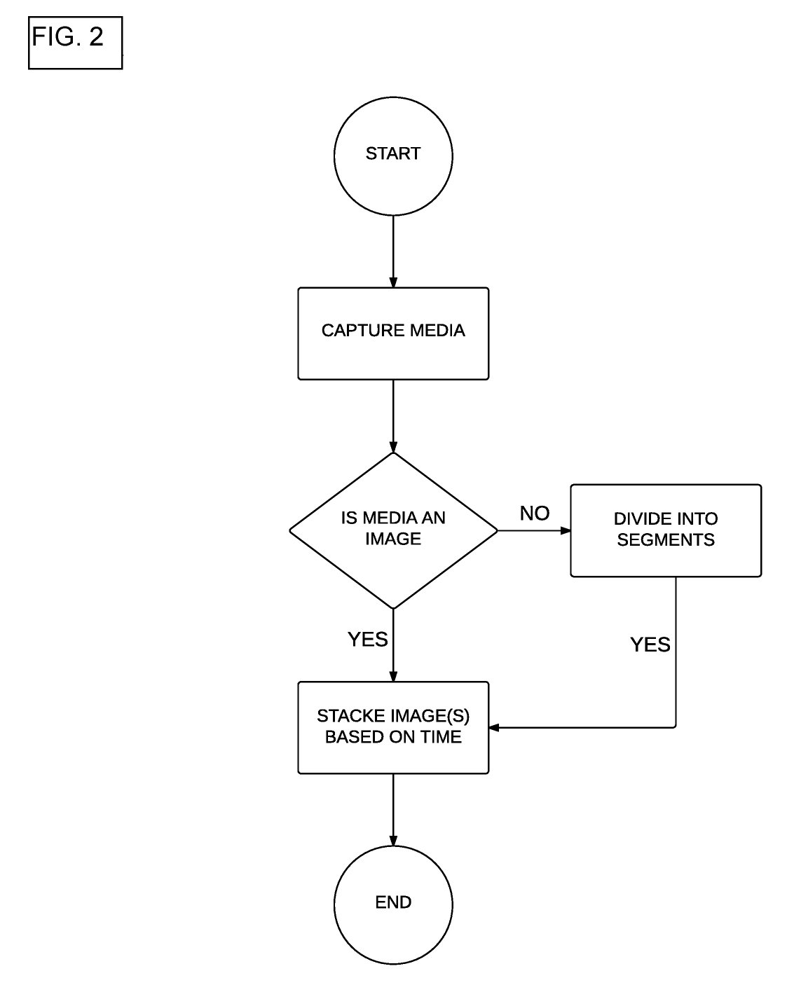

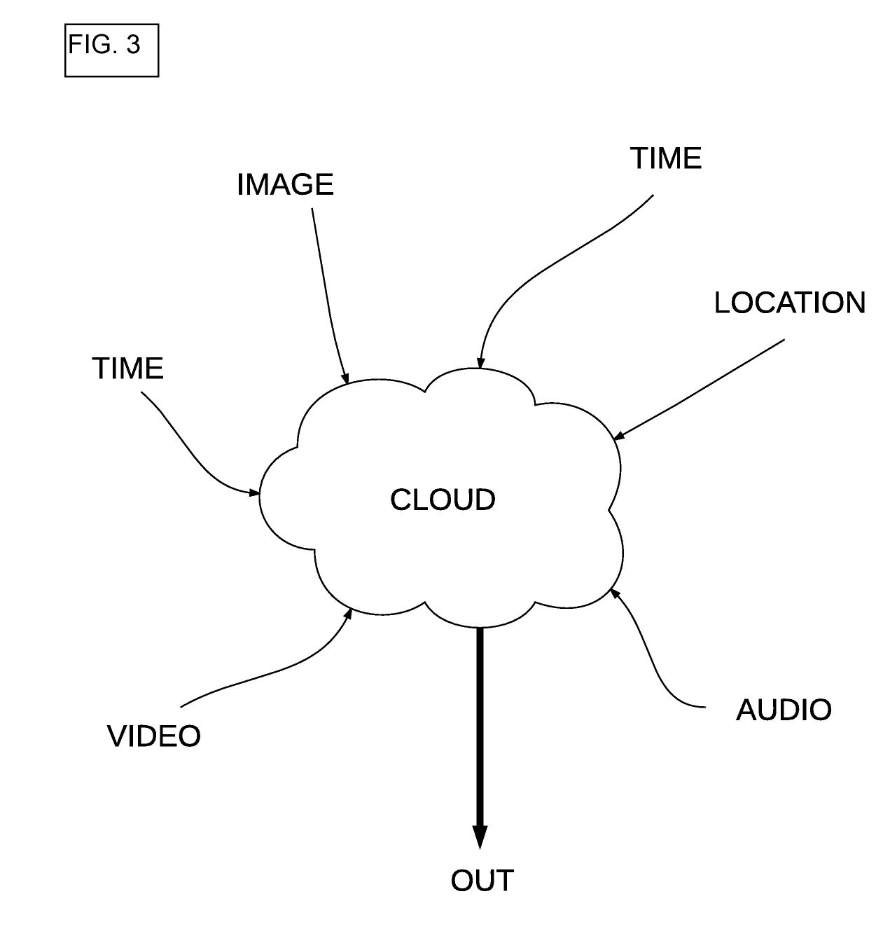

Referring now to FIGS. 2 and 3, a media file is uploaded to the system. In case where a user wishes to upload a video, the system converts the video to a sequence of images. For example, if the uploaded video had a framerate of 24 frames per second, the system will splice the video into 24 images per one second timeframe. The system then tags every image with the exact date and time it was taken. The system “stacks” the images based on the time it was recorded by the image capturing device (such as a cellphone, tablet, camera etc.) rather than the image quality, pixel count, hash tag, description, origin etc.

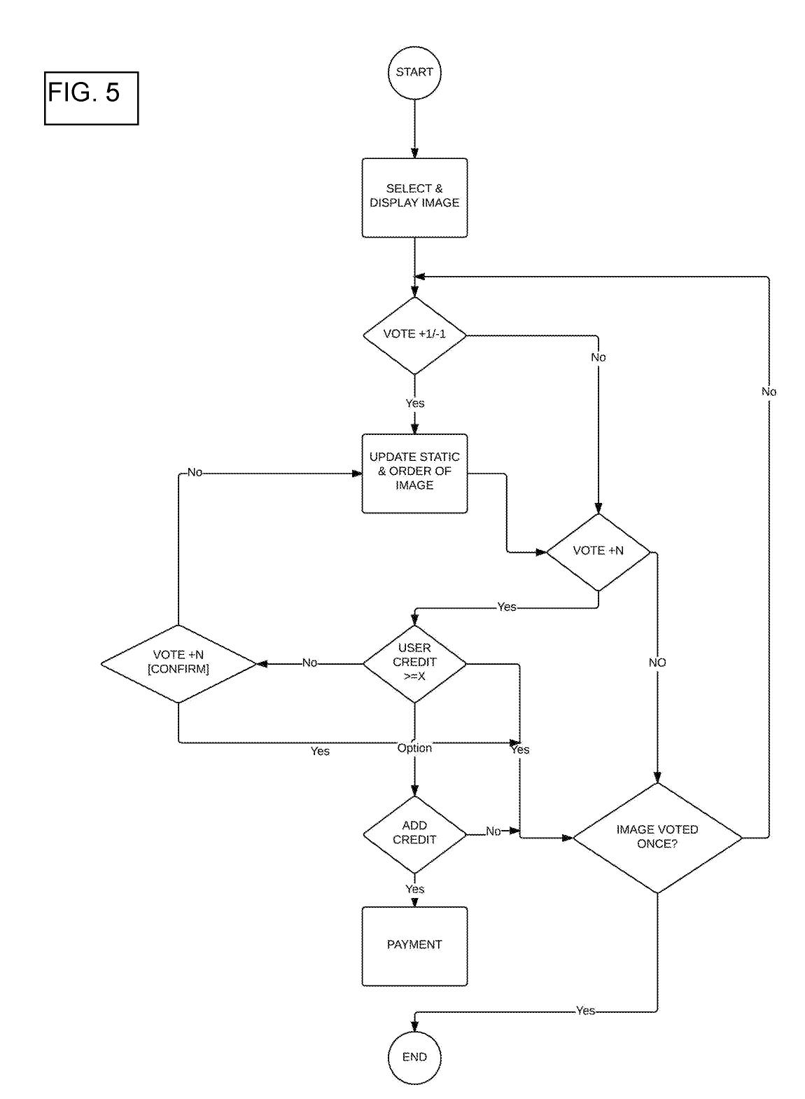

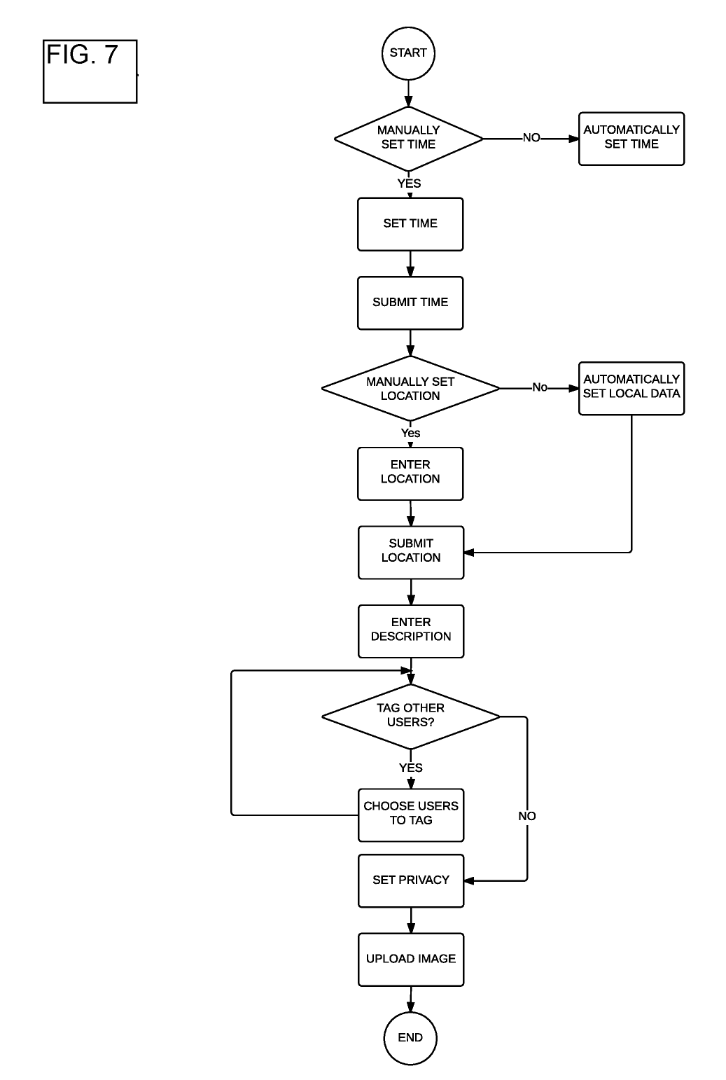

In some circumstance the user will require uploading an image that was taken in the past. In that instance the system will look for the time tag the user gives it as well as the location the image was taken. If there is no location or time data the system will reject the file (See FIG. 7). Since the time tag was not verified by the device it was taken with, the quality of the time tag given by the user will be verified by credits (see FIG. 5 below).

Once the image is recorded into the system with its time tag the secondary operation is to stack the images by the location (at what coordinates—where the image was taken). Since stacks of images are formed by dates and are clustered in groups based on the location, the system creates an ongoing upload of data creating a timeframe of history and sequence of events that happened at a certain location. This will create a time tree of events that happened in history that can be revisited image by image or played continuously as an infinite film with all the events that happened at a certain timeframe.

Accompanying the images of a video the audio will be parsed into frames of audio according to the current time of the images in the system. Images could be collage of different users, or one user, or only one video that the images part of. Images become part of the video according to their order in the stacks. These will be the output of the system.

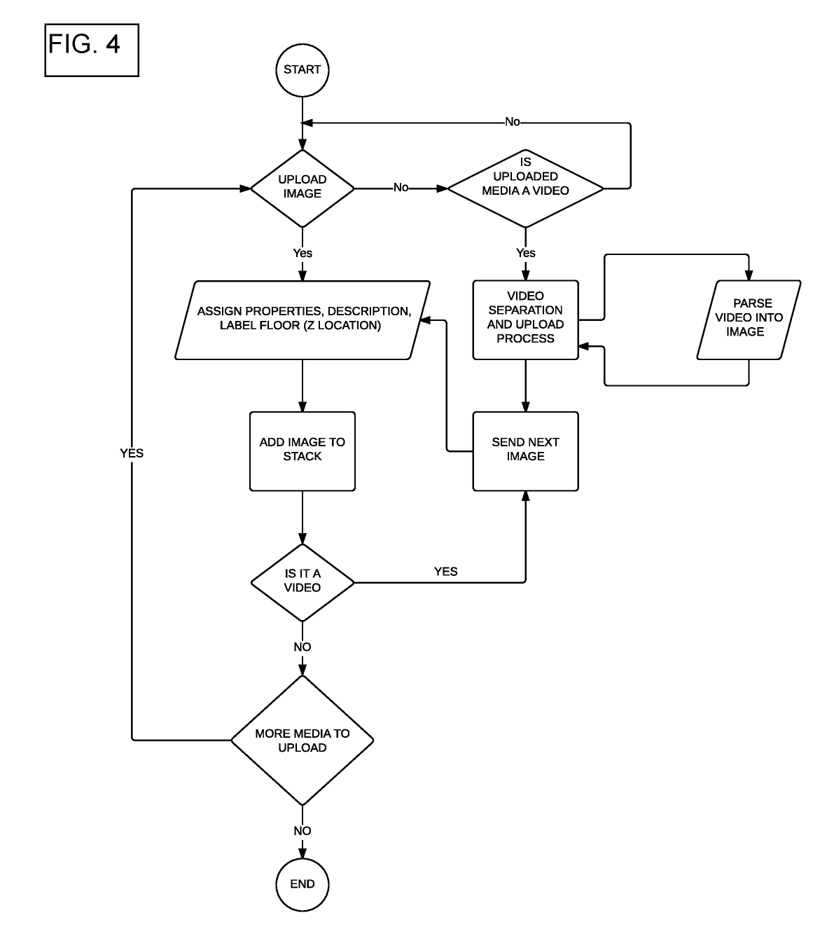

Once a user submits an image into the cloud, the system will tag all necessary information such as time image was taken, location and other user uploaded tags (FIGS. 3-4). The system then labels the media with a timestamp and then inserts it into a stack. The stacks are piles of images distributed on a map based on location (e.g. longitude, latitude). If an uploaded media is a video, the program will immediately divide into frames as described in FIG. 2.

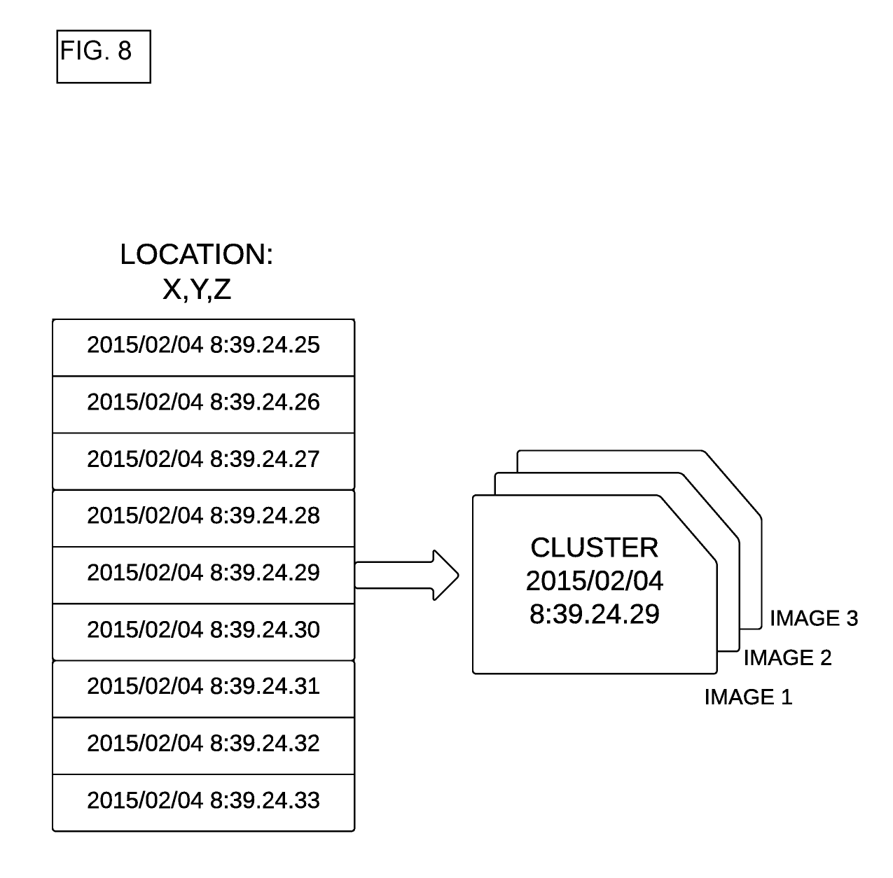

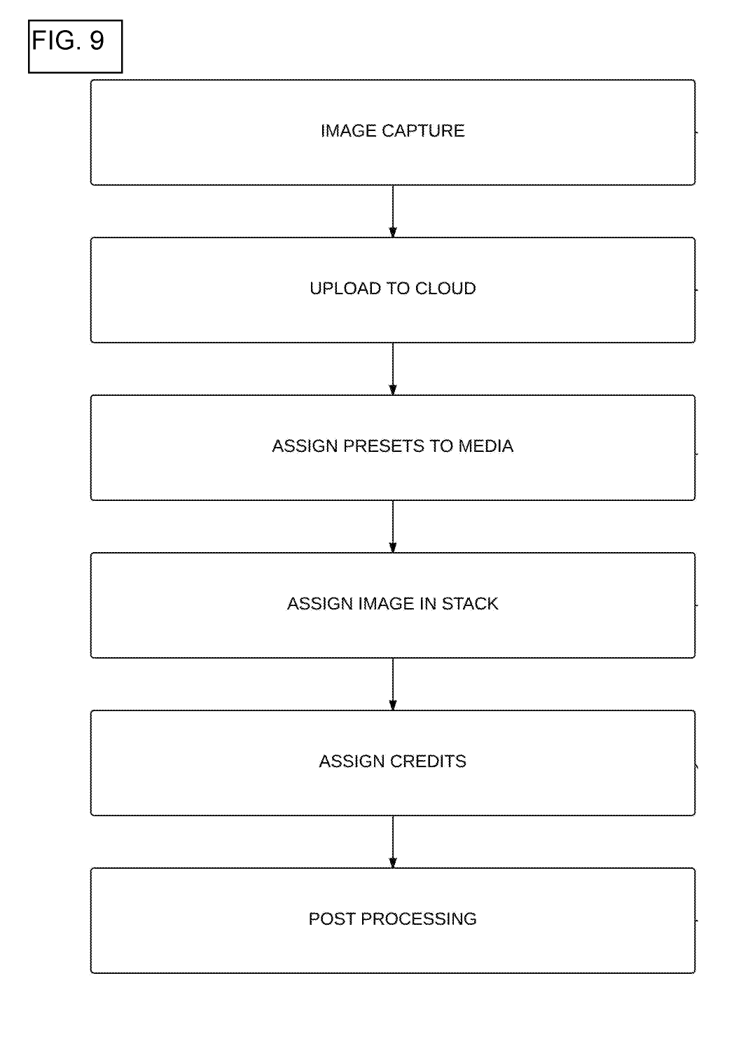

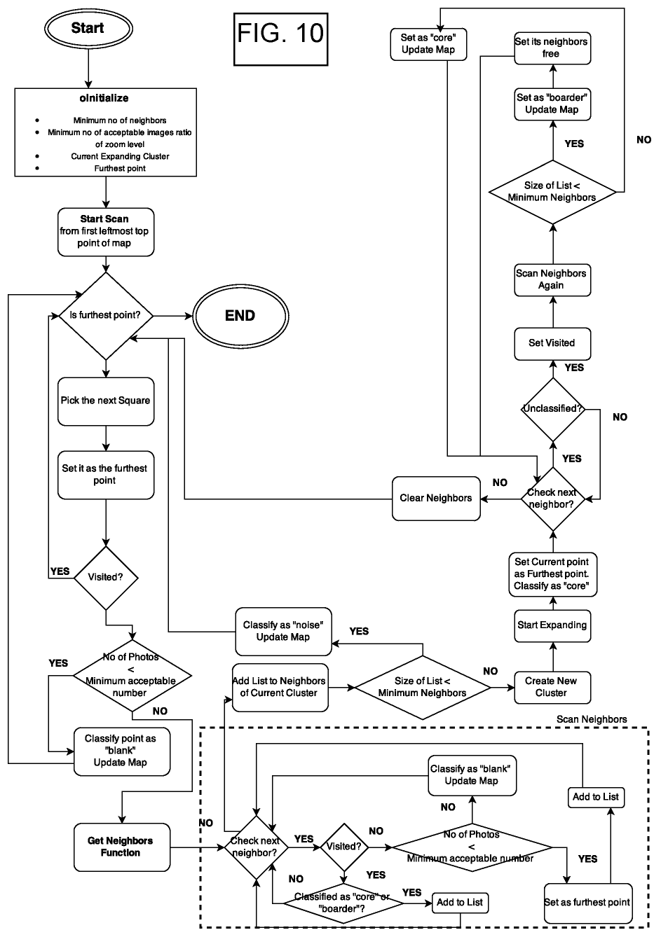

Turning now to FIG. 5, as the user count increases, there will be multiple uploads that have the same time stamp. For instance, during a football game, 340 users upload an image at the exact same time. The system will accept all of them but only by grouping them into a cluster—a Cluster is a group of images that were taken at the same time frame (see FIG. 8). Users will need to see an image that represents this time frame. In order to create a hierarchy in the cluster, the system will look into the total amount of credits an image has. Images in clusters will be ranked based on their credits. Image ranking within the cluster will be handled by votes (credits or points) given to the image by other users browsing through the map/website. Every user has the opportunity to up-vote or down-vote any image only once. However, if an image owner wishes to up-vote an image he/she can request it from the system using monetary funds which increases the ranking of the image.

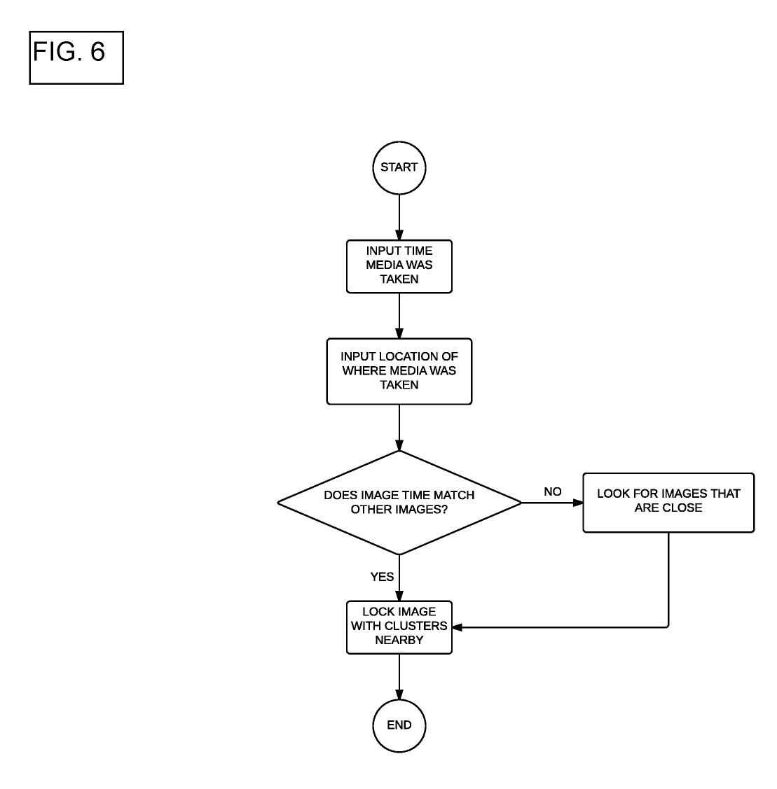

As shown in FIG. 6, a cluster is created initially by the location the images were taken as described in FIG. 5. Once an image is uploaded, the system will check whether or not the image coincides with other images at the same location. If it does, the system will automatically lock it into the same cluster as the other images in the same area/location. If the image does not match the location of any other images it will either set a location or deny the image

With reference to FIG. 7, if a user takes a picture in present time and wishes to upload to the main system he does not need to add a tag to the image since the system automatically detects the time the photo was taken. However, in a case where the user desires to upload an image from the past and the user has to input the time stamp manually, the system will require the user to enter a tag that represents a time and a date. This way, the system will automatically detect the date and arrange it into a stack. Every now and then, users tend to miss adding a tag to an image and the system has to detect and reject the image back.

FIG. 8 is a diagram that shows the way the images are clustered. On the left is the stacking of the images at location X,Y,Z. There are 9 images stacked that represent events that happened at that location. In this example, three users uploaded 3 separate images at 2015/02/04 8:39.24.29. The system will automatically cluster them creating a sub-group (shown on the right). Credits will be assessed to stack the highest credited image (Image 1) as mentioned in FIG. 5.

The system has a map that users can zoom in and out. Once the user is set on an area the system will automatically call it an “active area”. The system then divides the “active area” into multiple identical squares. These squares will store information such as the image count at every square. i.e. When the system analyses the active area it will see a cluster of squares with numbers on them (See FIG. 2).

There are two input variables that the system will look into that will be determined by the active area. These parameters are:

1. Minimum image count; and

2. Minimum amount in neighboring squares.

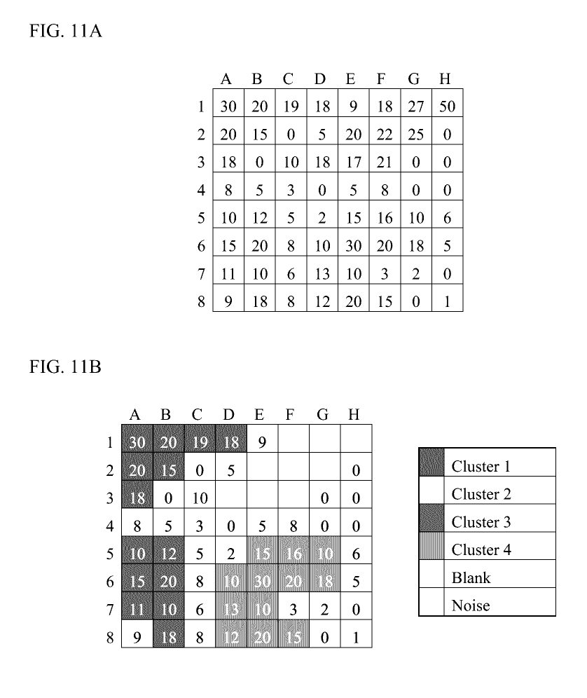

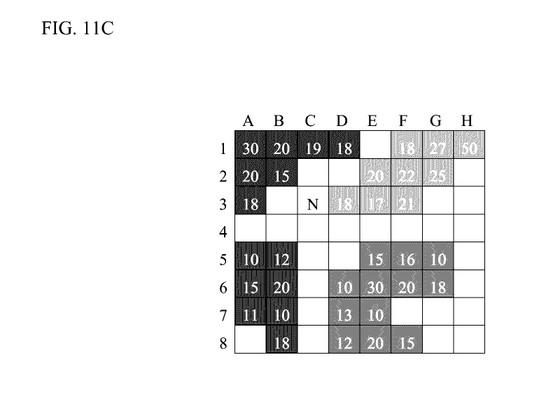

FIG. 11A is a sample table that a system might be able to compute.

As an example, based on FIG. 11A let us consider that:

1. The minimum image count: 10

2. The minimum neighbor count: 3

Based on these two numbers being set, the system will then automatically ignore squares that have an image count less than 10. It will be able to Cluster them into categories shown in FIG. 11B.

In FIG. 11B the system will start ignoring squares such as 4A, 4B, 4C etc. since they are under the value 10. These squares will be categorized as a blank square since they are below the value stated above as shown in FIG. 11C.

When the system looks into the second parameter “minimum neighbor count” it will detect square 3C as the only square that does not fit into the value. Hence it will label that square as “N” for Noise.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

What is claimed is:

1. A location-based social networking system, comprising:
a. a server;
b. a database in electronic communication with the server, the database having a plurality of content, each of the plurality of content associated with a location-specific content;
c. a content viewer on a mobile device in electronic communication with the server over the Internet, the content viewer showing a subset of the plurality of content to a user, the content location associated with each of the subset of the plurality of content within a predetermined distance of a current location of the mobile device, the subset of the plurality of content changing as the current location of the mobile device changes;
d. a location selector on the mobile device for the user to select one of the plurality of content locations, upon selection the subset of the plurality of content changing to include only content associated with the selected content location; and
e. a content creator on the mobile device accepting new content from the user, the new content associated with a new content location, the creation of the new content only allowed if the new content location is in proximity to the current location of the mobile device, upon creation the new content stored in the database as one of the plurality of content.

2. The system of claim 1 wherein the server comprises an interface in electronic communication with one or more providers over the Internet, the interface receiving some of the plurality of content from one of the one or more providers.

3. The system of claim 2 wherein the interface sends the new content to the one of the one or more providers.

4. The system of claim 2 wherein the one of the one or more providers is asocial networking provider.

5. The system of claim 1 wherein the server comprises more than one computer.

6. The system of claim 1 wherein the predetermined distance is provided by the user.

7. The system of claim 6 wherein the predetermined distance is selectable with one selectable value being a distance of 1 mile.

8. The system of claim 1 wherein the content creator associates the new content with one of the plurality of content locations.

9. The system of claim 1 wherein the new content location comprises an event.

10. The system of claim 1 further comprising a website interface on the server, the website interface allowing the user to view the plurality of content.

11. The system of claim 1 wherein the user comments on one of the subset of the plurality of content.

12. The system of claim 11 wherein comments are not allowed if the current location of the mobile device is not in proximity to the content location associated with the one of the subset of the plurality of content.

13. The system of claim 1 wherein the mobile device provides a notification of a change in the subset of the plurality of content.

14. The system of claim 1 wherein the creation of the new content is only allowed if the new content location is within 1 mile of the current location of the mobile device.

15. A method for location-based social networking, comprising the steps of:
a. providing a server;
b. storing in a database a plurality of content, each of the plurality of content associated with a content location, the database in electronic communication with the server;
c. providing on a mobile device a subset of the plurality of content, the content location associated with each of the subset of the plurality of content within a predetermined distance of a current location of the mobile device, the subset of the plurality of content changing as the current location of the mobile device changes;
d. providing a location selector on the mobile device for a user to select one of the plurality of content location, upon selection the subset of the plurality of content changing to include only content associated with the selected content location; and
e. receiving new content from the user with the mobile device, the new content associated with a new content location, the creation of the new content only allowed if the new content location is in proximity to the current location of the mobile device, upon creation the new content stored in the database as one of the plurality of content.

16. The method of claim 15 further comprising receiving on the server some of the plurality of content from one of one or more providers, the server in electronic communication with the one of the one or more providers over the Internet.

17. The method of claim 15 wherein the predetermined distance is selectable by the user.

18. The method of claim 15 further comprising the step of sending the new content to the one of the one or more providers.

19. The method of claim 15 further comprising the step of notifying the user of a change in the subset of the plurality of content.

20. The method of claim 15 wherein new content is only allowed if the new content location is within 1 mile of the current location of the mobile device.
